(19) United States
(12) Patent Application Publication
(10) Pub. No.: US 2017/0147909 A1
(43) Pub. Date: May 25, 2017

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Daisuke Izumi, Utsunomiya-shi (JP)

(21) Appl. No.: 15/358,580

(22) Filed: Nov. 22, 2016

(30) Foreign Application Priority Data
Nov. 25, 2015 (JP) 2015-229735
Oct. 19, 2016 (JP) 2016-205462

(51) Int. Cl. G06K 9/66; G06K 9/62; G06N 99/00

(52) U.S. Cl. CPC G06K 9/66; G06N 99/005; G06K 9/6277; G06K 9/627

(57) ABSTRACT

An information processing apparatus includes an acceptance unit configured to accept a plurality of training data given as data belonging to a specific category, the training data being used to determine a parameter of a classifier for determination for determining whether target data belongs to the specific category, a first data evaluation unit configured to obtain a first likelihood that the training data belongs to the specific category, and a parameter determination unit configured to determine the parameter of the classifier for determination based on the first likelihood of each of the plurality of training data.

### BACKGROUND

Field of Art

The present disclosure relates to an information processing apparatus, an information processing method, and a storage medium.

Description of the Related Art

As a method for automatizing appearance inspection to determine whether products manufactured in a factory are good or defective, a method using a large number of feature amounts has conventionally been known. According to such a method, a large number of feature amounts such as averages and maximum values of pixel values are extracted from images of a plurality of non-defective products and defective products for learning. A classifier for classifying non-defective products and defective products is trained on a feature space constituted by the extracted feature amounts. Whether an object to be inspected is a non-defective product or a defective product is then determined by using the classifier.

Such a method for detecting a defective product by image processing needs training data including errorless non-defective product data and defective product data to train an appropriate classifier. Japanese Patent Application Laid-Open No. 2011-70635 discuses a technique for removing inappropriate non-defective product data from non-defective product data included in a data set given as training data.

At the time of startup of an actual inspection process, a sufficient number of pieces of non-defective product data can be provided. However, a sufficient number of pieces of defective product data may fail to be prepared because the rate of occurrence of defective products is low. There is known a one-class classifier model in which a classifier can be trained on only one-label data. A one-class classifier learns a feature space expressing non-defective product data, and determines whether an object is a non-defective product or a defective product depending on whether the object belongs to the learned space.

However, even if the one-class classifier model is used, defective product data needs to be used to determine hyperparameters required in training the classifier, or a user needs to manually set the hyperparameters. Therefore, it has sometimes been difficult to train an appropriate classifier due to insufficient defective product data. If the user determines the hyperparameters, it has been difficult to determine appropriate hyperparameters.

### SUMMARY

According to an aspect of the present invention, an information processing apparatus includes an acceptance unit configured to accept a plurality of pieces of training data given as correct data, the training data being used to determine a parameter of a classifier for determination for determining whether target data is the correct data or incorrect data, a first data evaluation unit configured to obtain a first likelihood indicating a probability that the training data is the correct data, and a parameter determination unit configured to determine the parameter of the classifier for determination based on the first likelihood of each of the plurality of pieces of training data.

According to an aspect of the present invention, an appropriate parameter of the classifier may be determined even if a sufficient amount of defective product data is not available.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of an information processing apparatus.

FIG. 2 is a block diagram illustrating a software configuration of the information processing apparatus.

FIG. 3 is a flowchart illustrating learning processing.

FIG. 4 is a flowchart illustrating training data set classification processing.

FIG. 5 is a flowchart illustrating parameter determination processing.

FIG. 6 is a flowchart illustrating determination processing.

### DESCRIPTION OF THE EMBODIMENTS

Exemplary embodiments of the present invention will be described below with reference to the drawings.

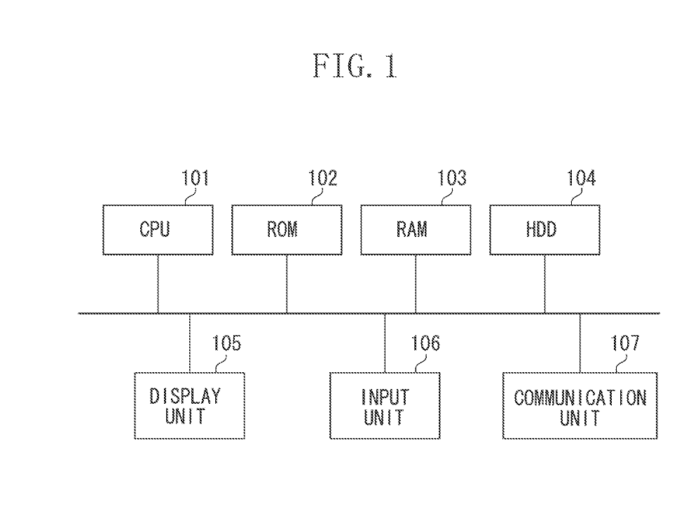

FIG. 1 is a diagram illustrating a hardware configuration of an information processing apparatus 100 according to a first exemplary embodiment. The information processing apparatus 100 trains a classifier for identifying correct answer data and incorrect answer data by using a training data set including a plurality of pieces of training data given as correct data. The information processing apparatus 100 further makes a determination whether target data to be determined is correct data or incorrect data by using the trained classifier.

The present exemplary embodiment will be described by using a case where the information processing apparatus 100 is used for appearance inspection of products in a factory as an example. In this case, captured images of non-defective products (non-defective product data) are used as correct data, and captured images of defective products (defective product data) as incorrect data. The information processing apparatus 100 then uses a trained classifier for determination to determine whether target data is non-defective product data or defective product data, with a captured image of an actual object to be inspected as the target data. Thus, whether the object to be inspected represented by the target data is a non-defective product or a defective product can be determined.

The information processing apparatus 100 includes a central processing unit (CPU) 101, a read-only memory (ROM) 102, a random access memory (RAM) 103, a hard disk drive (HDD) 104, a display unit 105, an input unit 106, and a communication unit 107. The CPU 101 reads a control program stored in the ROM 102 and performs various types of processing. The CPU 101 may include one or more processors. The ROM 102 stores an operating system (OS), processing programs, and device drivers. The RAM 103 is used as a temporary storage area such as a main memory and a work area of the CPU 101. The HDD 104 stores various types of information including image data and various programs in a non-transitory computer readable medium. Functions and processing of the information processing apparatus 100 to be described below are implemented by the CPU 101 reading the programs stored in the ROM 102 or the HDD 104 and executing the programs.

The display unit 105 displays various types of information. The input unit 106 includes a keyboard and a mouse, and accepts various operations made by a user. The communication unit 107 performs communication processing via a network with an external apparatus such as an image forming apparatus.

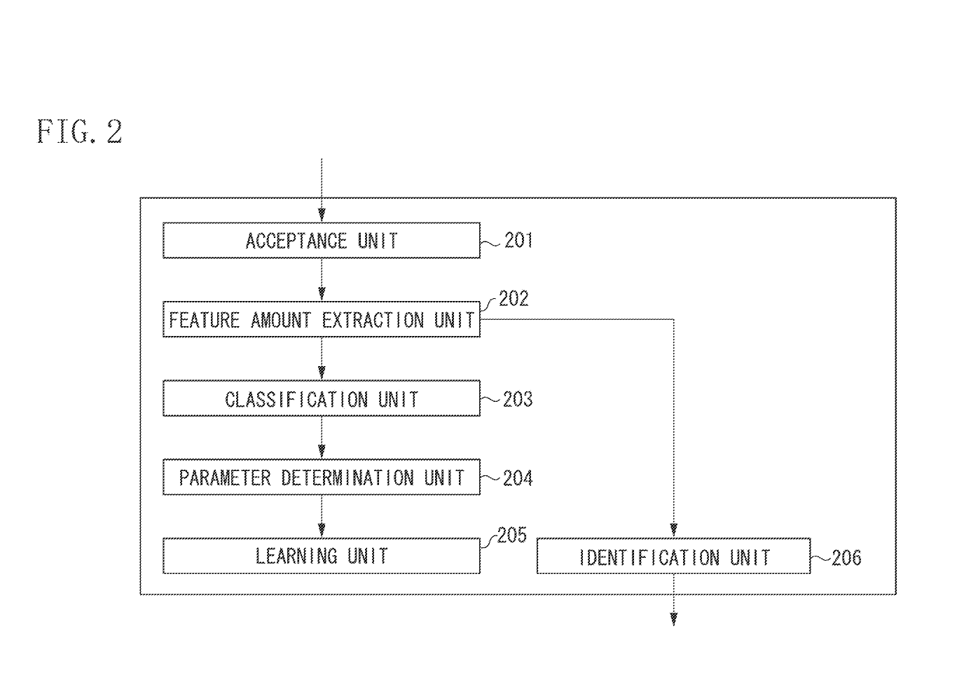

FIG. 2 is a block diagram illustrating a software configuration of the information processing apparatus 100. The information processing apparatus 100 includes an acceptance unit 201, a feature amount extraction unit 202, a classification unit 203, a parameter determination unit 204, a learning unit 205, and an identification unit 206. The acceptance unit 201 accepts input of training data and determination target data. In the present exemplary embodiment, the training data is data for which whether it is non-defective product data or defective product data is known. On the other hand, the determination target data is data for which whether it is non-defective product data or defective product data is unknown. The determination target data is data to be determined whether to be a non-defective product or defective product. The feature amount extraction unit 202 extracts feature amounts of the training data and the determination target data. The classification unit 203 evaluates the probability that each piece of training data is non-defective product data based on the feature amounts, and classifies the training data set into two data sets according to the evaluation result. The parameter determination unit 204 estimates a parameter of a classifier for determination. The learning unit 205 trains the classifier for determination (generates the classifier).

In addition, the information processing apparatus 100 may include the functional units illustrated in FIG. 2 as hardware components. In such a case, the information processing apparatus 100 may include arithmetic units and circuits corresponding to the functional units.

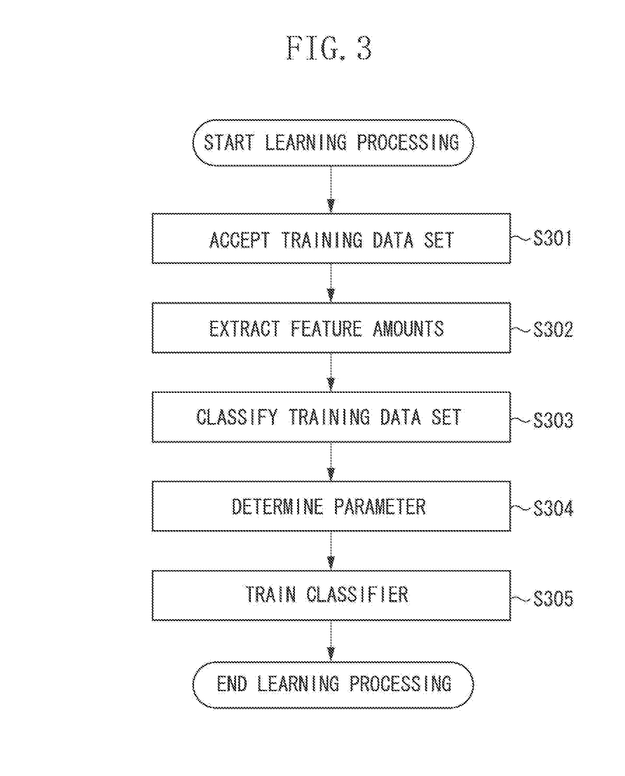

FIG. 3 is a flowchart illustrating learning processing by the information processing apparatus 100. In step S301, the acceptance unit 201 accepts a training data set. The training data set includes images serving as training data. Such images, or training images, are obtained by an imaging apparatus capturing images of objects to be inspected. The objects captured as the training images are known to be non-defective products in advance. In the present exemplary embodiment, the information processing apparatus 100 accepts images input from an external apparatus such as an imaging apparatus. In another example, the information processing apparatus 100 may read a training data set previously stored in its own storage unit such as the HDD 104.

In step S302, the feature amount extraction unit 202 extracts a predetermined plurality of types of feature amounts from each piece of training data. Examples of the feature amounts include an average, dispersion, skewness, kurtosis, mode value, and entropy of luminance values of an image. Other examples of the feature amounts include a texture feature amount obtained by using a co-occurrence matrix and a local feature amount obtained by using scale-invariant feature transform (SIFT). For the texture feature amount obtained by using a co-occurrence matrix and the local feature amount using SIFT, see Robert M. Haralick, K. Sharnmugam, and Itshak Dinstein, “Texture Features for Image Classification,” IEEE Transactions on Systems, Man, and Cybernetics, Vol. 6, pp. 610-621, 1973, and Lowe, David G., “Object Recognition from Local Scale-invariant Features,” Proceedings of the International Conference on Computer Vision, Vol. 2, pp. 1150-1157, 1999, respectively.

The feature amount extraction unit 202 extracts a predetermined plurality of feature amounts among such feature amounts. The feature amount extraction unit 202 obtains a feature vector formed by arranging the extracted plurality of feature amounts in order as a final feature amount. The types of the feature amounts to be extracted are recorded in the ROM 102 in the form of a setting file. The CPU 101 can change the contents of the setting file according to a user operation via the input unit 106.

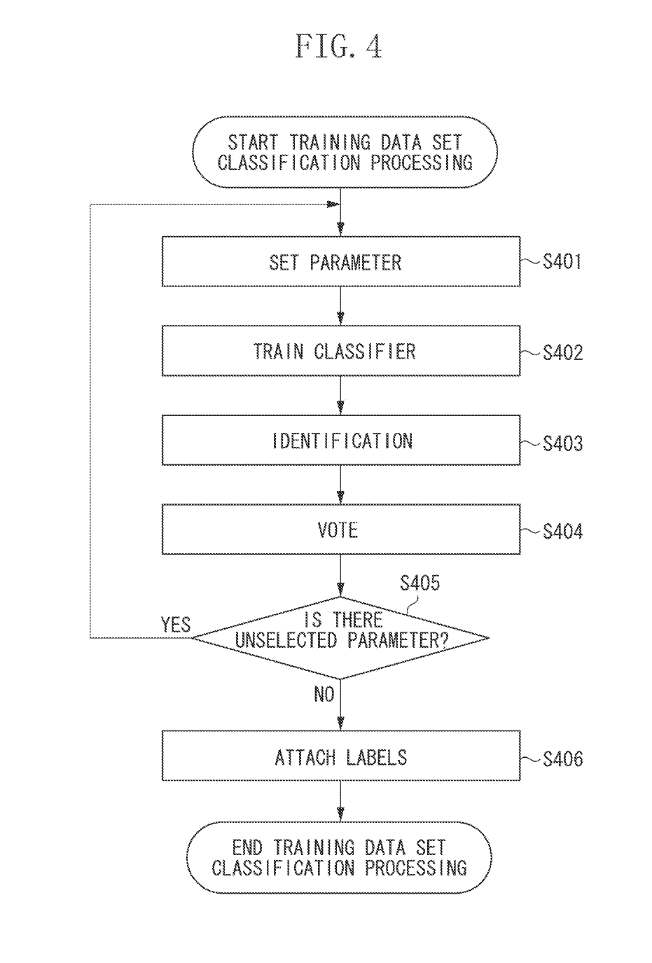

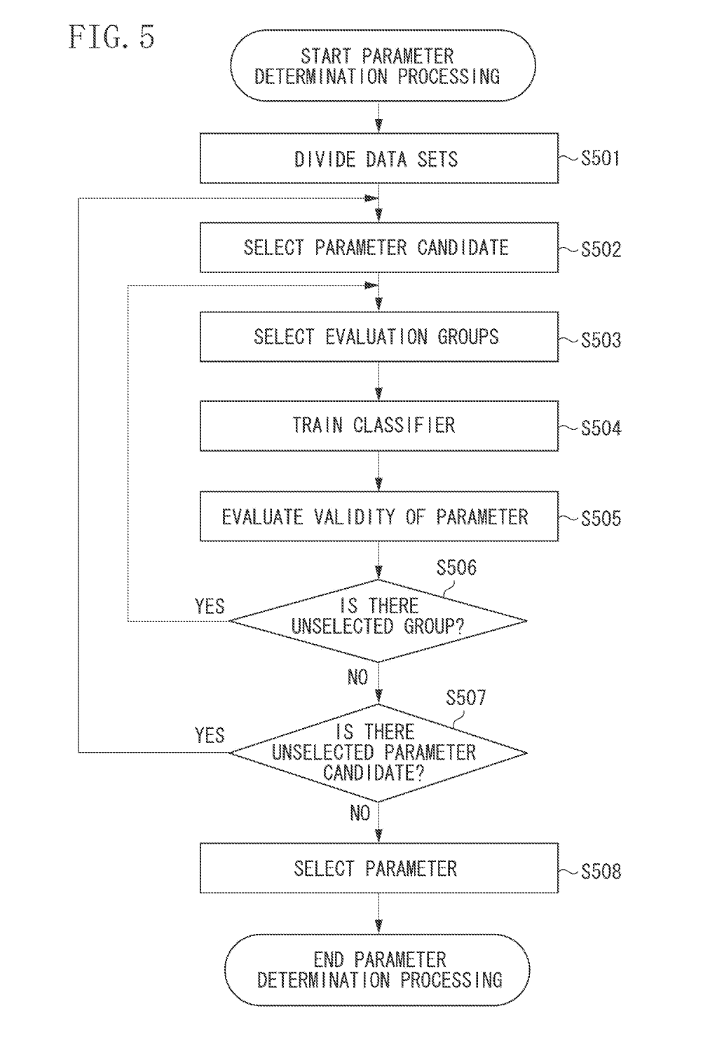

In step S303, the classification unit 203 classifies the training data set into two data sets of a non-defective product data set and a defective product candidate data set (training data set classification processing), and attaches labels indicating non-defective product data and defective product candidate data. This processing will be described in detail below with reference to FIG. 4. In step S304, the parameter determination unit 204 determines a parameter of the classifier based on the feature amounts obtained in step S303 and the labels attached in step S303. This processing will be described in detail below with reference to FIG. 5.

In step S305, the learning unit 205 trains the classifier for determination based on the feature amounts obtained in step S303 and the parameter determined in step 3304. With that, the learning processing ends. In the present exemplary embodiment, a one-class support vector machine (SVM) is used as the classifier. For a one-class SVM, see the following document:

Corinna Cortes, Vladimir Vapnik, (1995). “Support-vector networks”. Machine Learning 20 (3): 273-297.

In the present exemplary embodiment, a one-class SVM is used as the classifier. However, the classifier may be of any classification model capable of classification, and not limited to that of the exemplary embodiment. Other examples of the classifier may include ones using the Mahalanobis distance, a projection distance method, which is a type of a subspace method, and a neural network.

FIG. 4 is a flowchart illustrating detailed processing of the training data set classification processing (step S303) that has been described with reference to FIG. 3. Suppose that the training data set accepted in step S301 is D={d₁, d_, d₃, . . . , d_{N}}. N is the number of pieces of training data included in the training data set. Each piece of training data is expressed as dᵢ={xᵢ, lᵢ} (1≦i≦N). Here, xᵢ is a feature amount vector, and lᵢ is a label attached to each piece of training data. In the present exemplary embodiment, all the pieces of training data are non-defective product data. Therefore, a label indicating non-defective product data (lᵢ=+1) is attached to the accepted training data. If no label is attached to the training data, the acceptance unit 201 attaches (sets) a label to each piece of training data.

In step S401, the classification unit 203 sets a hyperparameter

φ(φεΦ)

which is required for the training of the classifier. In the present exemplary embodiment, a one-class SVM is used as the classifier. A candidate set Φ of hyperparameters φ may be prepared in advance and stored in the HDD 104 of the information processing apparatus 100. The candidate set Φ may be updated based on a result of learning with an arbitrary hyperparameter φ. The hyperparameter φ of the one-class SVM may be a C parameter which determines an allowable range of misclassification. If a radial basis function (RBF) kernel is used, a γ parameter of the RBF kernel serves as the hyperparameter φ. If a classifier using the subspace method is used other than the one-class SVM, the hyperparameter φ is the number of dimensions of the subspace. If a neural network is used, the hyperparameter φ is the number of nodes of a hidden layer or output layer. If dimension reduction is performed on the number of dimensions of the input feature amounts, a portion that determines the reduced number of dimensions may be the hyperparameter φ. For example, if principal component analysis (PCA) is used to perform the dimension reduction, the reduced number of dimensions may be determined from a contribution ratio. In this case, a plurality of patterns of contribution ratios may be prepared and included in the candidate set Φ of hyperparameters φ for calculation. The method of dimension reduction is not limited to PCA, and other methods may be used. Hereinafter, the hyperparameter φ will be referred to simply as a parameter φ.

In step S402, the classification unit 203 trains a classifier by using the parameter φ set in step S401 and the training data set D. The classifier trained here is a classifier for learning, which is used to classify the training data set D. In the present exemplary embodiment, the same classifier as the one for determination, which is used in determination processing, is used to classify the training data set D. In another example, a different type of classifier from that for determination may be used.

In step S403, the classification unit 203 performs identification processing on the training data. Specifically, by using the classifier trained in step S403, the classification unit 203 obtains a degree of membership sᵢ of training data xᵢ to a non-defective product class as follows:

sᵢ=f(xᵢ|φ).

The degree of membership sᵢ is an example of a likelihood (i.e., the probability of being non-defective product data (correct data)) dependent on the classifier for learning. The processing of step S403 is an example of data evaluation processing for obtaining a likelihood dependent on the classifier for learning.

In step S404, the classification unit 203 performs voting processing expressed in formula 1 by comparison processing between the degree of membership sᵢ and a threshold Tᵥ. More specifically, the classification unit 203 votes for training data having the degree of membership sᵢ smaller than the threshold Tᵥ:

$${v}_{i} ← {v}_{i} + \{ \begin{matrix}1 , & if {s}_{i} < {T}_{v} \\ 0 , & otherwise\end{matrix} \qquad ( 1 )$$

The processing of step S404 is an example of data evaluation processing for obtaining the likelihood of the training data based on a plurality of likelihoods dependent on the classifier for learning.

In the present exemplary embodiment, the classification unit 203 votes for data having the degree of membership sᵢ smaller than the threshold Tᵥ. However, the voting processing is not limited thereto. In another example, the classification unit 203 may vote based on a ratio to the number of pieces of data N included in the training data set D, instead of the threshold Tᵥ. In the present exemplary embodiment, the value of a vote is 1. In another example, the classification unit 203 may determine the value of a vote by weighting. For example, the classification unit 203 may cast a vote having a value proportional to the degree of membership sᵢ as expressed by formula 2. In another example, the classification unit 203 may determine the value from the rank in all the degrees of membership sᵢ in the training data set D as expressed by formula 3:

$$\begin{matrix}{v}_{i} ← {v}_{i} + \{ \begin{matrix}- {s}_{i} , & if {s}_{i} < {T}_{v} \\ 0 , & otherwise\end{matrix} & ( 2 ) \\ {v}_{i} ← {v}_{i} + Rank ( {s}_{i} \vert S ) & ( 3 )\end{matrix}$$

Here, S is the set of the degrees of membership sᵢ. More specifically, S={s₁, s₂, s₃, . . . , s_{N}}.

Rank(s|S)

is a function for returning the rank of a degree of membership s when the pieces of data included in the degree of membership set S are sorted in descending order.

In step S405, the classification unit 203 determines whether there is an unselected parameter φ. If there is an unselected parameter φ (YES in step S405), the processing returns to step S401. In step S401, the classification unit 203 selects an unselected parameter φ from the candidate set Φ of parameters φ, sets the selected parameter φ, and continues the subsequent processing. If there is no unselected parameter φ (NO in step S405), the processing proceeds to step S406.

In step S406, the classification unit 203 determines whether training data xᵢ is non-defective product data or defective product candidate data based on the voting result. More specifically, in formula 4, if vᵢ is greater than or equal to a threshold Tₕ, the classification unit 203 determines that the training data xᵢ is defective product candidate data, and attaches the label of defective product candidate data (lᵢ=0) to the training data xᵢ. On the other hand, if vᵢ is smaller than the threshold Tₕ, the classification unit 203 determines that the training data xᵢ is non-defective product data, and attaches the label of non-defective product data (lᵢ=+1) to the training data xᵢ. The training data set D is thereby classified into the two data sets, i.e., the non-defective product data set and the defective product candidate data set. In other words, this processing is an example of classification processing for classifying a plurality of pieces of training data into two data sets.

$${l}_{i} = \{ \begin{matrix}0 , & if {v}_{i} \geq {T}_{h} \\ + 1 , & otherwise\end{matrix} \qquad ( 4 )$$

FIG. 5 is a flowchart illustrating detailed processing of the parameter determination processing (step S304) described with reference to FIG. 3. In the present exemplary embodiment, the parameter determination unit 204 determines the parameter φ by using a cross validation method. While the present exemplary embodiment uses the cross validation method to determine the hyperparameter φ, techniques other than the cross validation method may be used.

A typical cross validation method will be described. In the cross validation method, non-defective product data and defective product data in a training data set D are divided each into K groups. The K divided groups but one are used for learning, and the remaining one group is used for evaluation (validation). More specifically, a non-defective product data set D_{OK}, which is a group of pieces of non-defective product data, is divided into K groups. One of the K groups is denoted by D_{OK(1)}, and the other groups by D_{OK(K-1)}. Similarly, a defective product data set D_{NG}, which is a group of pieces of defective product data, is divided into K groups. One of the K groups is denoted by D_{NG(1)}, and the other groups by D_{NG(K-1)}. To evaluate an arbitrary parameter, a classifier is trained by using the non-defective product groups D_{OK(K-1)} and the defective product groups D_{NG(K-1)}. A degree of separation between the remaining non-defective product group D_{OK(K-1)} and defective product group D_{NG(1)} is calculated by using the trained classifier. Such processing is repeated to make evaluations by replacing the training groups and the evaluation groups, and a parameter is selected. In such a manner, a parameter that most separates the non-defective product data set D_{OK} and the defective product data set D_{NG} can be selected.

However, if the parameter φ for classifying the non-defective product data and the defective product candidate data in the present exemplary embodiment is selected by the above-described method, there is a classification boundary between the non-defective product data and the defective product candidate data. As a result, the defective product candidate data can be determined to be defective product data although the defective product candidate data is given by the user as non-defective product data. In the present exemplary embodiment, the following processing is performed to select a parameter φ with which the non-defective product data is determined to have a higher probability of being a non-defective product than the defective product candidate data, not a parameter that separates the non-defective product data from the defective product candidate data.

In step S501, the parameter determination unit 204 divides the training data set D into a non-defective product data set D_{OK} and a defective product candidate data set D_{NGC} based on the labels attached in step S303. The parameter determination unit 204 divides each data set into K groups. In step S502, the parameter determination unit 204 selects a parameter candidate. In step S503, the parameter determination unit 204 selects one group D_{OK(1)} as an evaluation group from the K groups of the non-defective product data set D_{OK}. Similarly, the parameter determination unit 204 selects one group D_{NGC(1)} as an evaluation group from the K groups of the defective product candidate data set D_{NGC}.

In step S504, the parameter determination unit 204 trains a classifier by using the non-defective product groups D_{OK(K-1)} other than the evaluation group D_{OK(1)} and the defective product candidate group D_{NGC(K-1)} other than the evaluation group D_{NGC(1)}. In other words, the parameter determination unit 204 trains the classifier for learning by assuming both the non-defective product data and the defective product candidate data to be non-defective product data (learning processing). In step S505, the parameter determination unit 204 evaluates validity of the parameter used in the training of step S504 by using the evaluation groups D_{OK(1)} and D_{NGC(1)} selected in step S503 (parameter evaluation processing). In the present exemplary embodiment, the area under the curve (AUC) is used as an evaluation value. More specifically, the parameter determination unit 204 calculates an evaluation value C(φ) by the following equation:

C(φ)=AUC(D_{OK(1)},D_{NGC(1)})

While, in the present exemplary embodiment, the AUC is used as the evaluation value, the evaluation value is not limited thereto. Any evaluation value that can evaluate the degree of separation between two classes may be used. Examples include the Akaike information criterion (AIC) and the Bayesian information criterion (BIC).

In step S506, the parameter determination unit 204 checks whether there is a group that has not been selected as an evaluation group. If there is an unselected group (YES in step S506), the processing returns to step S503. In step S503, the parameter determination unit 204 selects unselected groups as the evaluation groups D_{OK(1)} and D_{NGC(1)}, and performs the subsequent processing. In such a manner, the parameter determination unit 204 repeats the processing of steps S502 to S505 while changing the evaluation groups D_{OK(1)} and D_{NGC(1)}. On the other hand, if all the groups have been selected as an evaluation group (NO in step S506), the processing proceeds to step S507.

In step 3507, the parameter determination unit 204 checks whether there is an unselected parameter candidate. If there is an unselected parameter candidate (YES in step S507), the processing returns to step S502. In step S502, the parameter determination unit 204 selects an unselected parameter candidate, and performs the subsequent processing. In such a manner, the parameter determination unit 204 calculates the evaluation value C(φ) for each parameter candidate. On the other hand, if all the parameter candidates have been selected (NO in step S507), the processing proceeds to step S508.

In step S508, the parameter determination unit 204 selects an appropriate parameter φ by using the plurality of evaluation values that are obtained for each parameter candidate by repeating the processing of steps S502 to S505. For example, the parameter determination unit 204 determines an average of the plurality of evaluation values obtained for each parameter candidate and selects a parameter φ that maximizes the average. In another example, the parameter determination unit 204 may select a parameter φ that maximizes a minimum value among the plurality of evaluation values for each parameter candidate. In another example, the parameter determination unit 204 may obtain a median value of the plurality of evaluation values for each parameter candidate and select a parameter φ that maximizes the median value. With that, the parameter determination processing ends.

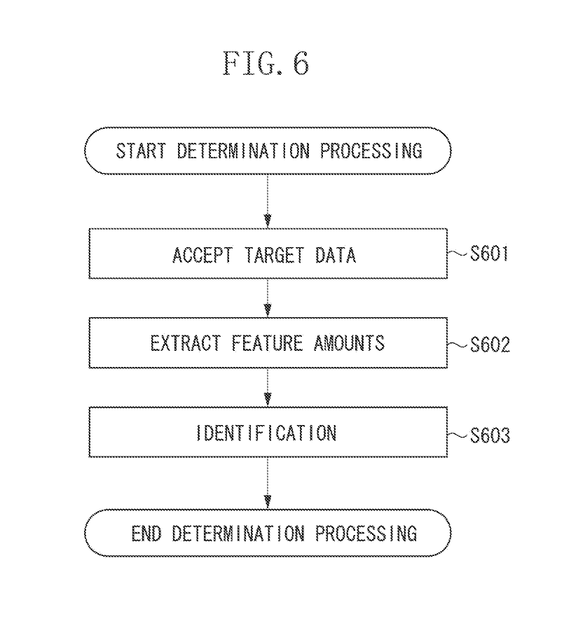

FIG. 6 is a flowchart illustrating determination processing by the information processing apparatus 100. The determination processing is processing for determining whether a captured image of an object to be inspected is non-defective product data or defective product data, by using the classifier for determination obtained by the learning processing described with reference to FIG. 3. In step S601, the acceptance unit 201 accepts a captured image of the object to be inspected, i.e., target data. In the present exemplary embodiment, the acceptance unit 201 accepts the target data from an imaging apparatus. In another example, the information processing unit 100 may read target data stored in its own storage unit such as the HDD 104.

In step S602, the feature amount extraction unit 202 extracts a predetermined plurality of types of feature amounts from the target data. The types and number of feature amounts to be extracted here are the same as those of feature amounts extracted in step S302. In another example, in step S602, the feature amount extraction unit 202 may extract only a feature amount or amounts by which the target data can be classified as non-defective product data or defective product data by using the classifier obtained by the learning processing.

In step S603, the identification unit 206 identifies whether the target data is non-defective product data or defective product data based on the feature amounts extracted in step S602, by using the classifier obtained by the learning processing. With that, the determination processing ends.

As described above, in the present exemplary embodiment, the parameter determination unit 204 trains a classifier by assuming that the training data of both of the non-defective product groups and the defective product candidate groups is non-defective product data. On the other hand, in evaluating the trained classifier, the parameter determination unit 204 calculates the degree of separation (evaluation value) by assuming that the training data of the non-defective product groups is non-defective product data and the training data of the defective product candidate groups is defective product data. Therefore, the classifier for determination trained with the selected parameter # determines the training data given as the non-defective product data by the user to be non-defective product data. However, the training data classified into the defective product candidate data set D_{N}C is determined to have a lower value of probability to be non-defective product data than the training data classified into the non-defective product groups.

Suppose the classifier is trained by assuming that only the training data of the non-defective product data set D_{OK} without the defective product candidate data set D_{NGC} is non-defective product data. In such a case, a parameter φ that separates the non-defective product data set D_{OK} and the defective product candidate data set D_{NGC} is selected. As a result, the trained classifier may determine that target data belonging to the defective product candidate data set D_{NGC} is defective product data. In contrast, according to the present exemplary embodiment, the parameter determination unit 204 trains the classifier by using not only the training data of the non-defective product data set D_{OK} but also the training data of the defective product candidate data set D_{N}r as non-defective product data. As a result, the classifier can be trained so that the training data classified into the defective product candidate data set D_{NGC} is determined to have a lower value of probability to be non-defective product data than the training data classified into the non-defective product groups. In other words, an appropriate parameter φ of the classifier for determination can be determined from only the training data set D that is known to be non-defective product data in advance.

The information processing apparatus 100 according to the present exemplary embodiment performs both the learning processing and the determination processing. Instead, the information processing apparatus 100 may be configured to perform only the learning processing. In such a case, the classifier obtained by the learning processing is set into an apparatus for performing the determination processing, different from the information processing apparatus 100. Then, the apparatus for performing the determination processing performs the determination processing.

Next, an information processing apparatus 100 according to a second exemplary embodiment will be described. The information processing apparatus 100 according to the second exemplary embodiment trains a classifier for identifying correct data and incorrect data by using a training data set including correct data and a small amount of incorrect data. The second exemplary embodiment will also be described by using a case where the information processing apparatus 100 is used for appearance inspection of products in a factory as an example. Therefore, the correct data is captured images of non-defective products (non-defective product data). The incorrect data is captured images of defective products (defective product data).

If a sufficient amount of training data serving as defective product data is provided in training a classifier for determination, the classifier for determination can be trained by using both non-defective product data and the defective product data. However, if the amount of defective product data is small, the resulting classifier may overfit the small amount of defective product data, and the separation accuracy between the non-defective product data and the defective product data may be decreased. Similar to the information processing apparatus 100 according to the first exemplary embodiment, the information processing apparatus 100 according to the second exemplary embodiment performs processing by classifying training data given as non-defective product data into a non-defective product data set and a defective product candidate data set. Differences of the information processing apparatus 100 according to the second exemplary embodiment from the information processing apparatus 100 according to the first exemplary embodiment will be described below.

The learning processing by the information processing apparatus 100 according to the second exemplary embodiment will be described with reference to FIG. 3. In the second exemplary embodiment, in step S301, the acceptance unit 201 accepts a training data set including both training data given as non-defective product data and a small amount of training data given as defective product data. Hereinafter, the training data given as non-defective product data will be referred to as non-defective product training data. The training data given as defective product data will be referred to as defective product training data.

Labels (lᵢ=+1) indicating a group of pieces of non-defective product data are attached to the training data given as non-defective product data, included in the training data set. Labels (lᵢ=−1) indicating a group of pieces of defective product data are attached to the training data given as defective product data. If no label is attached to the training data, the acceptance unit 201 attaches (sets) labels to the respective pieces of training data.

In the feature amount extraction processing (step S302), the feature amount extraction unit 202 performs the processing for extracting feature amounts in the same manner as described in the first exemplary embodiment, with the non-defective product training data as the processing target. In the following training data set classification processing (step S303), the classification unit 203 classifies the non-defective product training data into a non-defective product data set D_{OK} and a defective product candidate data set D_{NGC} in a manner similar as described in the first exemplary embodiment.

The following parameter determination processing (step S304) will be described with reference to FIG. 5. In the second exemplary embodiment, the parameter determination unit 204 evaluates the parameter candidates by using not only the training data of the defective product candidate data set D_{NGC} but the defective product training data as well. More specifically, in step S504, the parameter determination unit 204 trains the classifier by using the non-defective product groups D_{OK(K-1)} and the defective product candidate groups D_{NGC(K-1)}, as non-defective product data. In step S505, the parameter determination unit 204 calculates the degree of separation to evaluate the parameter candidate by using the defective product candidate group D_{NGC(K-1)} and the defective product data set D_{NG} as defective product data. The rest of the configuration and processing of the information processing apparatus 100 according to the second exemplary embodiment are the same as those of the information processing apparatus 100 according to the first exemplary embodiment.

As described above, if the defective product training data is insufficient, the information processing apparatus 100 according to the second exemplary embodiment trains the classifier for determination by assuming part of the training data of the non-defective product data set D_{OK} to be defective product data similar as described in the first exemplary embodiment. An appropriate parameter φ that does not overfit the defective product training data can thus be determined.

The information processing apparatus 100 only can determine the parameter φ by using defective product data, and the specific processing thereof is not limited to that of the exemplary embodiments. For example, in step S505, the parameter determination unit 204 calculates the degree of separation

L(D_{OK(1)}|D_{NGC(1)})

between the non-defective product group D_{OK(1)} and the defective product candidate group D_{NGC(1)}. The parameter determination unit 204 further calculates the degree of separation

L(D_{OK(1)}|D_{NG})

between the non-defective product group D_{OK(1)} and the defective product data set D_{NG}. The parameter determination unit 204 may use a product L′ of the two degrees of separation expressed by formula 5 as the evaluation value:

L′(D_{OK(1)}|D_{NGC(1)},D_{NG})=L(D_{OK(1)}|D_{NGC(1)})×L(D_{OK(1)}|D_{NG}) (5)

In another example, as expressed by formula 6, the parameter determination unit 204 may use a linear sum of the two degrees of separation as the evaluation value:

L′(D_{OK(1)}|D_{NGC(1)},D_{NG})=w₁L(D_{OK(1)}|D_{NGC(1)})+w₂L(D_{OK(1)}|D_{NG}) (6)

In another example, considering that the defective product candidate group D_{NGC(1)} is training data given as non-defective product data, the parameter determination unit 204 may use a product of the degrees of separation expressed by formula 7 or formula 8 as the evaluation value:

L′(D_{OK(1)}|D_{NGC(1)},D_{NG})=L(D_{OK(1)}|D_{NGC(1)})×L(D_{OK(1)}|D_{NG})×L(D_{NGC(1)}|D_{NG}) (7)

L′(D_{OK(1)}|D_{NGC(1)},D_{NG})=L(D_{OK(1)}|D_{NGC(1)})×L(D_{NGC(1)}|D_{NG}) (8)

As expressed by formula 9 or formula 10, the parameter determination unit 204 may use a linear sum of the degrees of separation as the evaluation value:

L′(D_{OK(1)}|D_{NGC(1)},D_{NG})=w₁L(D_{OK(1)}|D_{NGC(1)})+w₂L(D_{OK(1)}|D_{NG})+w₃L(D_{NGC(1)}|D_{NG}) (9)

L′(D_{OK(1)}|D_{NGC(1)},D_{NG})=w₁L(D_{OK(1)}|D_{NGC(1)})+w₂L(D_{NGC(1)}|D_{NG}) (10)

According to the above-described exemplary embodiments, an appropriate parameter φ of the classifier can be determined even if a sufficient amount of defective product data is not available.

The exemplary embodiments of the present invention have been described in detail above. The present invention is not limited to a specific exemplary embodiment, and various changes and modifications may be made without departing from the gist of the present invention described in the claims.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2015-229735, filed Nov. 25, 2015, and No. 2016-205462, filed Oct. 19, 2016, which are hereby incorporated by reference herein in their entirety.

What is claimed is:

1. An information processing apparatus comprising:
an acceptance unit configured to accept a plurality of training data used to generate a classifier for determining whether target data belongs to a specific category;
a first data evaluation unit configured to obtain a first likelihood that the training data belongs to the specific category; and
a parameter determination unit configured to determine a parameter of the classifier based on the first likelihood of each of the plurality of training data.

2. The information processing apparatus according to claim 1, wherein the first data evaluation unit is configured to determine the first likelihood based on a feature amount of the training data.

3. The information processing apparatus according to claim 1, further comprising:
a first learning unit configured to generate a plurality of classifiers for learning by using a respective plurality of parameters and the training data; and
a second data evaluation unit configured to determine a second likelihood dependent on each of the plurality of classifiers for learning by using the classifier for learning, the second likelihood that the training data belongs to the specific category,
wherein the first data evaluation unit is configured to obtain the first likelihood of the training data based on a plurality of second likelihoods obtained with respect to the training data by the second data evaluation unit.

4. The information processing apparatus according to claim 3, wherein the first learning unit is configured to generate the identifiers for learning by using the respective plurality of parameters and a feature amount of the training data.

5. The information processing apparatus according to claim 1, further comprising a classification unit configured to classify the plurality of training data into a first data set and a second data set based on the first likelihood, the second data set having a lower likelihood of being the specific category data than the first data set,
wherein the parameter determination unit is configured to determine the parameter based on the first data set and the second data set.

6. The information processing apparatus according to claim 5, further comprising:
a second learning unit configured to generate a classifier for learning by using each of a plurality of parameters, assuming that the training data of both the first data set and the second data set is correct data; and
a parameter evaluation unit configured to evaluate each of the parameters used for learning by the second learning unit, assuming that the training data of the first data set is correct data and the training data of the second data set is incorrect data,
wherein the parameter determination unit is configured to determine the parameter of the classifier for determination from among the plurality of parameters based on an evaluation result of the parameter evaluation unit.

7. The information processing apparatus according to claim 6, wherein the parameter evaluation unit is configured to evaluate the parameters based on a degree of separation between the training data of the first data set and the training data of the second data set.

8. The information processing apparatus according to claim 6,
wherein the acceptance unit is configured to further accept incorrect training data given as incorrect data, and
wherein the parameter evaluation unit is configured to evaluate the parameters by further using the incorrect training data.

9. The information processing apparatus according to claim 8, wherein the parameter evaluation unit is configured to evaluate the parameters based on a degree of separation between the training data of the first data set and the training data of the second data set, and a degree of separation between the training data of the first data set and the incorrect training data.

10. The information processing apparatus according to claim 9, wherein the parameter evaluation unit is configured to evaluate the parameters based on a degree of separation between the training data of the second data set and the incorrect training data.

11. The information processing apparatus according to claim 8, wherein the parameter evaluation unit is configured to evaluate the parameters based on a degree of separation between the training data of the first data set and the incorrect training data, and a degree of separation between the training data of the second data set and the incorrect training data.

12. The information processing apparatus according claim 1, further comprising a third learning unit configured to train the classifier for determination based on the parameter determined by the parameter determination unit.

13. An information processing method performed by an information processing apparatus, the information processing method comprising:
accepting a plurality of training data given as data belonging to a specific category, the training data being used to determine a parameter of a classifier for determination for determining whether target data belongs to the specific category;
obtaining a first likelihood that the training data belongs to the specific category; and
determining the parameter of the classifier for determination based on the first likelihood of each of the plurality of training data.

14. A storage medium storing a program for causing a computer to function as units of an information processing apparatus, the information processing apparatus comprising:
an acceptance unit configured to accept a plurality of pieces of training data given as data belonging to a specific category, the training data being used to determine a parameter of a classifier for determination for determining whether target data belongs to the specific category;
a first data evaluation unit configured to determine a first likelihood that the training data belongs to the specific category; and
a parameter determination unit configured to determine the parameter of the classifier for determination based on the first likelihood of each of the plurality of training data.
